(19) United States
(12) Patent Application Publication
(10) Pub. No.: US 2014/0293285 A1
(43) Pub. Date: Oct. 2, 2014

(54) LASER INSPECTION SYSTEM AND METHOD FOR INSPECTING A SPECIMEN

(71) Applicant: TECNATOM, S.A., Madrid (ES)

(72) Inventors: Santiago Sánchez Prieto, Madrid (ES); Cèsar Daniel Sànchez Muñoz, Madrid (ES); Esmeralda Cuevas Aguado, Madrid (ES)

(73) Assignee: TECNATOM, S.A., Madrid (ES)

(21) Appl. No.: 13/853,667

(22) Filed: Mar. 29, 2013

(51) Int. Cl. G01N 21/47; G01B 9/02

(52) U.S. Cl. CPC G01N 21/47; G01B 9/02
USPC 356/450; 356/445

(57) ABSTRACT

An inspection system and method for inspecting a specimen (2) having: a positioning equipment (16) for positioning the specimen (2) in a position according to a desired orientation for inspection, a laser generator (1) for generating shot beams (3) to shoot at the specimen (2), and generating ultrasonics in the specimen (2), a laser detector (5) for detecting the reflected beams (4) from the specimen (2) and generating a detected signal (6), an optical interferometer (7) connected to the laser detector (5) to extract information from the detected signal (6) and translating the information from the detected signal (6) into a measurable intensity modulation signal (8), an acquisition equipment (12) with an A/D converter (10) and a control module (14) for synchronizing the shot beams (11) and the acquisition equipment (12).

### TECHNICAL FIELD OF THE INVENTION

The present invention relates to systems and methods of non destructive testing for inspecting parts having high dimensional, geometrical and integrity requirements.

### BACKGROUND OF THE INVENTION

The systems known in the art are used for inspecting large parts. Said systems have the part to be inspected held according to an inspecting position and the inspecting element moving along a trajectory to obtain the desired data from the part.

WO02057769 discloses a system for identifying ultrasonic displacements in a material under test utilizing a time-varying output pulse of a first laser beam. The system includes a seed laser light source for providing a laser beam, a modulating assembly in the path of propagation of the laser beam for time-varying of the laser beam, at least one optical isolation assembly placed in the path of propagation of the laser beam for preventing reflected laser light feedback into the seed laser light source, and at least one laser light amplification assembly placed in the path of propagation of the laser beam for amplifying the laser beam which passes the amplified time-varying output pulse of the laser beam.

U.S. Pat. No. 7,612,894B2, relates to an improved laser for the optical detection of ultrasound. The primary task of this “first” detection laser is to illuminate the spot where a “second” laser is used to generate ultrasound in the part under test. The scattered light from the first laser is collected and analyzed with an interferometer to demodulate the surface vibrations caused by the return echoes of the ultrasound at the surface of the part. The improved detection laser (first laser) is constructed using a diode-pumped fiber laser to produce a high power single-frequency laser source.

WO2009140523A1, discloses a laser transmission system for laser machining of a workpiece. The laser transmission system comprises a source coupled via a lens and a transmissive block to a transmission fibre. The fibre output is coupled via a further transmissive block and a lens onto the workpiece. Control of the system is possible due to an optical detection system monitoring ultrasound waves generated on the workpiece.

Laser ultrasonic technology combines two lasers in order to perform the inspection of the part: a high peak power pulsed laser for generation, a detection laser, an optical interferometer, a photo detector, a digitizer and a module control to synchronize laser shots and measurement acquisition.

Below are described the main components of such systems:
Laser:

The operating principle of selected LUS (Laser Ultrasonic System) technology is based on the synchronization between the two lasers, to be able to generate ultrasounds in the materials and detect said ultrasounds properly. Two of the most common laser generally used are Nd:YAG (neodymium-doped yttrium aluminium garnet) for detection laser and CO₂ for generation laser. Both of these lasers generate a very concentrated beam of light but they react differently depending on the material. A beam delivery equipment (optic device) is used for guiding or transporting the laser, usually a mirror guide for the CO₂ (generation laser) and optic fiber for the Nd:YAG (detection laser). The laser shall not damage at all the inspection surface of the component. In particular, no additional surface treatment is envisaged for RTM (resin transfer moulding) parts.
Interferometer:

The interferometer shall allow extracting the information contained in the detection laser. That information is coded in phase modulation. The interferometer translates this phase modulation into an intensity modulation that can be measured.
Photo Detector:

The photo detector, as part of the detection chain, is associated to the interferometer. Usually, a dark surface like the surface the composites have doesn't reflect so much light into the collecting system. This phenomenon is also amplified when work with high incidence angles is carried out. This is the reason why special efforts must be dedicated to have an electronic circuit able to reduce the noise and adjust the gain in order to perform an inspection with very low light level back from the part. The photo detector sensitivity must be large enough to overcome that constraint.
Acquisition Chain:

In order to recover data, the analog signal must be converted into an exploitable digital signal. The different parameters of the ND converter must be carefully chosen according to the other elements of the system (mainly the detection chain characteristics).

The solutions proposed in the state of the art make use of a LUS wherein the laser is moved to inspect the part while the part to be inspected is held in a fixed position. This architecture results in a series of drawbacks: it is necessary to provide the inspection system with a robust positioning means to support and move the structure of the laser; in addition, a high power motor is required to move the positioning means holding the laser; the bulk of the equipment comprising the robust positioning means together with the high power motor, complicate the room requirements to locate the system and the transport of the system; the weight of the positioning means and the high power of the motor imply high levels of power supply being consumed. It also becomes difficult to achieve the precision required in the movement when the object being moved has a high inertia. The combination of high precision in the movement with a high inertia of the object being moved leads to only slow movements being affordable, since faster movements would lead to accelerations unbearable either by the motor or by the positioning means or by both. Said slow movements add up to a long time required to inspect a part or specimen. If the inspection of manufactured parts is a stage in the production line, either the production cadency is slowed down or just a small sample of all the parts being manufactured can be inspected. It becomes apparent that there still remain problems to be solved that the present invention solves.

### DESCRIPTION OF THE INVENTION

The invention refers to an inspection laser system and a method for inspecting a specimen. The LUS of the invention is devoted to the non destructive inspection of detail parts. The system and method of the invention achieves high cadences of inspection. Said high cadences of inspection are achieved by the system and method of the invention because of the combination of several features: on the one side, because the inspecting means comprises a laser system and, on the other side, because the main movements in the inspection system are carried out by positioning means, for instance a robot, positioning a part to be inspected, in other words, the specimen, in a position according to a desired orientation for inspection.

A first aspect of the invention refers to an inspection system for inspecting a specimen having:
1) a laser generator, for generating shot beams to shoot at the specimen and configured to be aimed at the specimen to obtain reflected beams from the specimen;
2) a laser detector for detecting the reflected beams from the specimen and configured to generate a detected signal;
3) positioning means for positioning the specimen in a position according to a desired orientation for inspection.

A second aspect of the invention refers to a method for inspecting a specimen comprising:
a) positioning the specimen in a position according to a desired orientation for inspection by the positioning means;
b) aiming a laser generator at the specimen;
c) generating a laser by the laser generator;
d) triggering the laser generator or generating shot beams to shoot at the specimen;
e) obtaining reflected beams from the specimen;
f) detecting the reflected beams from the specimen by a laser detector;
g) generating a detected signal;
h) extracting information coded in phase modulation from the laser detector by an optical interferometer;
i) translating the information coded in phase modulation into a measurable intensity modulation signal by an optical interferometer;
j) building an analog signal from the measurable intensity modulation signal by an acquisition means;
k) reducing noise and adjusting a gain by a photodetector to enable inspection with low light level reflected beams from the specimen;
l) converting the analog signal into a digital signal by an A/D converter;
m) synchronizing the shot beams and the acquisition means by a control module.

### DESCRIPTION OF THE DRAWINGS

To complement the description being made and in order to help to a better understanding of the characteristics of the invention, as an integral part of said description, a set of drawings is attached wherein by way of illustration and not limitation, the following has been represented (according to a preferred embodiment of the same):

FIG. 1 is a schematic drawing of the system of the invention.

FIG. 2 is a view of an inspection table.

In these, references appearing therein have the following meanings:

(1) laser generator

(2) specimen

(3) shot beams

(4) reflected beams

(5) laser detector

(6) detected signal

(7) optical interferometer

(8) measurable intensity modulation signal

(9) photodetector

(10) A/D converter

(11) digital signal

(12) acquisition means

(13) analog signal

(14) control module

(15) scanner

(150) beam delivery means

(151) beam movements

(152) inspection plane

(16) positioning means, robot

(17) generation optic

(18) generation beams

(19) detection optic

(20) detection beams

(21) capture optic

(22) inspection table

(23) reference system

(24) fixtures

(25) tooling table

(26) positioners

### PREFERRED EMBODIMENT OF THE INVENTION

To facilitate the understanding of the invention the laser ultrasonic inspection system and method for inspecting a specimen will be describe next.

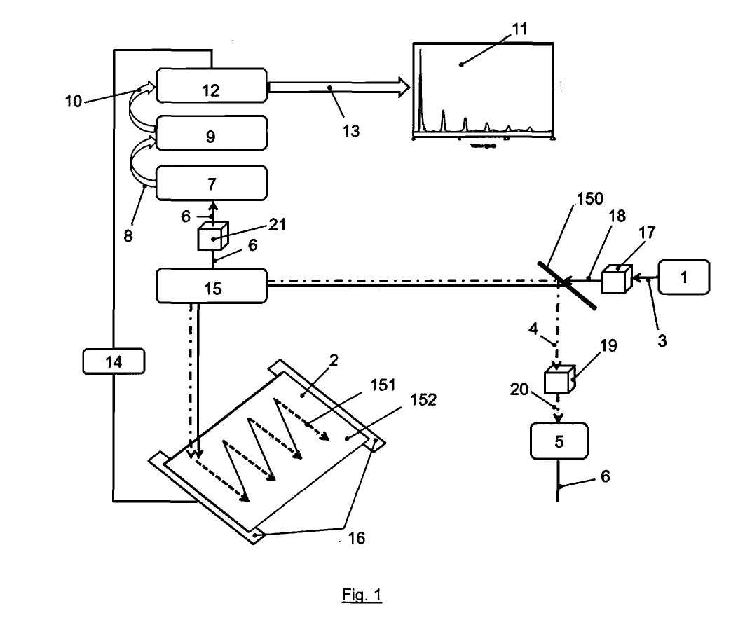

FIG. 1 shows a first embodiment of the invention. The invention refers to an inspection system for inspecting a specimen (2) having:
a laser generator, (1) (it could be a laser ultrasonics emitter, a high peak power pulsed laser) for generating shot beams to shoot at the specimen (2) and configured to be aimed at the specimen (2) to obtain reflected beams from the specimen (2);
a laser detector for detecting the reflected beams from the specimen (2) and configured to generate a detected signal;
movable positioning means for positioning the specimen (2) in a position according to a desired orientation for inspection.

The inspection system of the invention further comprises:
a scanner (15) between the laser generator (1), the laser detector (5) and the specimen (2) for detecting and generating beam movements (151) over the specimen (2) to be inspected; a two-dimensional matrix comprising an inspection plane (152) to be inspected by the beam movements (151) is defined in the scanner (15); said inspection plane (152) in combination with the movements of the positioning means (16) allows a complete inspection of the specimen (2) meeting quality inspection requirements within an acceptable inspection time;
an inspection table (22) comprising a plurality of positioners (26), said positioners (26) being a replication of specific zones of the specimen (2) to locate the specimen (2) in an unequivocal way;
an optical interferometer (7) connected to the laser detector (5) and configured to extract information from the detected signal (6) and to translate the information from the detected signal (6) into a measurable intensity modulation signal (8);
acquisition means (11) connected to the optical interferometer (7) and configured to build an analog signal (13) from the measurable intensity modulation signal (8);
a photodetector (9) situated between the optical interferometer (7) and the acquisition means (12), having a sensitivity (large enough) configured to reduce noise and adjust a gain to enable inspection with low light level reflected beams (4) from the specimen (2);
an A/D converter (10) connected to an output of the acquisition means (12) for converting the analog signal (13) into a digital signal (11);
a control module (14) for synchronizing the shot beams (3) and the acquisition means (12);
a generation optic (17) between the laser generator (1) and the specimen (2) for focalizing and aligning the shot beams (3) to obtain generation beams (18);
a detection optic (19) between the laser detector (5) and the specimen (2) for focalizing and aligning the reflected beams (4) to obtain detection beams (20) and for collecting light;
a capture optic (21) for converting optical data into electrical data between the optical interferometer (7) and the scanner (15).

The detected signal (6) comprises information coded in phase modulation.

The invention also refers to a method for inspecting a specimen (2) comprising:
a) positioning the specimen (2) in a position according to a desired orientation for inspection by the positioning means (16);
b) aiming a laser generator (1) at the specimen (2);
c) generating a laser by the laser generator (1);
d) triggering the laser generator (1) for generating shot beams (3) to shoot at the specimen (2);
e) obtaining reflected beams (4) from the specimen (2);
f) detecting the reflected beams (4) from the specimen (2) by a laser detector (5).

The method system of the invention further comprises:
a) generating a detected signal (6);
b) extracting information coded in phase modulation from the laser detector (5) by an optical interferometer (7);
c) translating the information coded in phase modulation into a measurable intensity modulation signal (8) by an optical interferometer (7);
d) building an analog signal (13) from the measurable intensity modulation signal (8) by an acquisition means (12);
e) reducing noise and adjusting a gain by a photodetector (9) to enable inspection with low light level reflected beams (4) from the specimen (2);
f) converting the analog signal (13) into a digital signal (11) by an A/D converter (10);
g) synchronizing the shot beams (3) and the acquisition means (12) by a control module (14).

The method system of the invention further comprises:
a) placing the specimen (2) on an inspection table (22);
b) locating the specimen (2) in a pre-inspection position by means of a plurality of positioners (26), said positioners (26) being a replication of specific zones of the specimen (2) to locate the specimen (2) in an unequivocal way;
c) obtaining specimen (2) details for enhancing specimen (2) inspection.

The LUS system can integrate all the operations needed to perform the LUS inspection in different modules: LUS inspection cell management, Calibration, Acquisition and Evaluation. The following parameters can be controlled and/or monitored in said different modules:
Command electronic components of the laser: laser alignment, visualize scanning area, power check, distance to the part, laser spot sizes, laser energy, interferometer stabilization, acquisition rate (Hz) . . .
Command elements of inspection cell: Robot (16) movements, definition of trajectories for automatic mode operation, auxiliary elements movements, safety elements . . .
Monitor Laser status: laser power status, interferometer values (interferometer stabilization and ramp signal from Fabry-Perot), detection laser status, CO₂ laser status (firing, alignment), Front shutter open, Internal shutter, chiller error
Monitor Inspection cell Status: scan mode (active, pause, cancelled, error), robot (16) coordinates, robot (16) status . . .
Alarm management: control and/or monitoring of all the information coming from Inspection Cell: interlocks, safety alarms, emergency stop
System configuration: fine tuning of parameters for different inspection settings.
Database management: parts (name, dimensions, manufacture process, material, photo . . . ), trajectories (name, operator, model, estimated time), inspections (acquisition data). The database helps the user to organize the generated information linked with LUS inspection data. It is possible to add, edit or delete information in the database. It is possible also to load predefined information (trajectory, part . . . ) from the database.

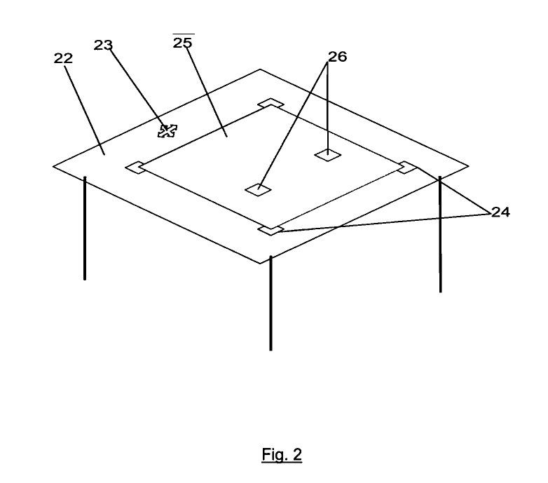

FIG. 2 shows some elements of the invention taking part in the process flow. The part or specimen (2) to be inspected is positioned in the Inspection Cell over the inspection table (22) in the correct position. This inspection table (22) is provided with different non intrusive tooling to locate the parts (2) in a unique position to ensure repeatability. The inspection table (22) is fixed to the ground, with a plates system that allows a leveling during assembly.

The following items can be mounted on the inspection table (22):
A reference system (23) to reference the inspection table (22) with the robot (16).
Four angled fixtures (24) fixed to the inspection table (22) to be the reference when a tooling table (25) for parts (2) inspection is mounted on the inspection table (22).

The tooling provided with the inspection table (22) to locate the parts (2) in a unique position, comprises the following items:
A tooling table (25), the same for all the parts or specimens (2) to be inspected
A plurality of positioners (26) over the tooling table (25). Said positioners (26) are a replication of some specific zones of the part or specimen (2) to be inspected. This will be used to locate the part or specimen (2) in an unequivocal way. These positioners (26) can be manufactured by additive printer to reduce their cost.

1. An inspection system for inspecting a specimen (2) having:
a) a laser generator (1):
for generating shot beams (3) to shoot at the specimen (2);
configured to be aimed at the specimen (2) to obtain reflected beams (4) from the specimen (2);
b) a laser detector (5):
for detecting the reflected beams (4) from the specimen (2);
configured to generate a detected signal (6);
comprising:
c) movable positioning means (16) for positioning the specimen (2) in a position according to a desired orientation for inspection.

2. The inspection system of claim 1 further comprising a scanner (15) between the laser generator (1), the laser detector (5) and the specimen (2) for detecting and generating beam movements (151) over the specimen (2) to be inspected.

3. The inspection system of claim 2 wherein a two-dimensional matrix comprising an inspection plane (152) to be inspected by the beam movements (151) is defined in the scanner (15).

4. The inspection system of claim 1 further comprising an inspection table (22) comprising a plurality of positioners (26), said positioners (26) being a replication of specific zones of the specimen (2) to locate the specimen (2) in an unequivocal way.

5. The inspection system of claim 1 further comprising:
a) an optical interferometer (7) connected to the laser detector (5) configured to:
extract information from the detected signal (6);
translate the information from the detected signal (6) into a measurable intensity modulation signal (8);
b) acquisition means (12) connected to the optical interferometer (7) configured to build an analog signal (13) from the measurable intensity modulation signal (8);
c) a photodetector (9):
between the optical interferometer (7) and the acquisition means (12);
having a sensitivity configured to reduce noise and adjust a gain to enable inspection with low light level reflected beams (4) from the specimen (2);
d) an A/D converter (10) connected to an output of the acquisition means (12) for converting the analog signal (13) into a digital signal (11);
e) a control module (14) for synchronizing the shot beams (3) and the acquisition means (12).

6. The inspection system of claim 1 wherein the laser generator (1) is a laser ultrasonics emitter.

7. The inspection system of claim 1 wherein the laser generator (1) is a high peak power pulsed laser.

8. The inspection system of claim 1 further comprising a generation optic (17) between the laser generator (1) and the specimen (2) for focalizing and aligning the shot beams (3) to obtain generation beams (18).

9. The inspection system of claim 1 further comprising a detection optic (19) between the laser detector (5) and the specimen (2) for focalizing and aligning the reflected beams (4) to obtain detection beams (20) and for collecting light.

10. The inspection system of claim 3 further comprising a capture optic (21) for converting optical data into electrical data between the optical interferometer (7) and the scanner (15).

11. The inspection system of claim 1 wherein the detected signal (6) comprises information coded in phase modulation.

12. A method for inspecting a specimen (2) comprising:
a) positioning the specimen (2) in a position according to a desired orientation for inspection by the positioning means (16);
b) aiming a laser generator (1) at the specimen (2);
c) generating a laser by the laser generator (1);
d) triggering the laser generator (1) for generating shot beams (3) to shoot at the specimen (2);
e) obtaining reflected beams (4) from the specimen (2);
f) detecting the reflected beams (4) from the specimen (2) by a laser detector (5).

13. The method of claim 12 further comprising:
a) generating a detected signal (6);
b) extracting information coded in phase modulation from the laser detector (5) by an optical interferometer (7);
c) translating the information coded in phase modulation into a measurable intensity modulation by an optical interferometer (7);
d) building an analog signal (13) from the measurable intensity modulation signal (8) by an acquisition means (12);
e) reducing noise and adjusting a gain by a photodetector (9) to enable inspection with low light level reflected beams (4) from the specimen (2);
f) converting the analog signal (13) into a digital signal (11) by an A/D converter (10);
g) synchronizing the shot beams (3) and the acquisition means (12) by a control module (14).

14. The method of claim 12 further comprising:
a) placing the specimen (2) on an inspection table (22);
b) locating the specimen (2) in a pre-inspection position by means of a plurality of positioners (26), said positioners (26) being a replication of specific zones of the specimen (2) to locate the specimen (2) in an unequivocal way;
c) obtaining specimen (2) details for enhancing specimen (2) inspection.
